(19) United States
(12) Patent Application Publication
(10) Pub. No.: US 2008/0150800 A1
(43) Pub. Date: Jun. 26, 2008

(54) Phased Array Antenna Apparatus

(75) Inventor: Masatoshi Tsuji, Shiga (JP)

Correspondence Address: Cheng Law Group, PLLC, 1100 17th Street, N.W., Suite 503, Washington, DC, 20036, US

(73) Assignee: OPTEX CO., LTD, SHIGA JAPAN (JP)

(21) Appl. No.: 11/883,324

(22) PCT Filed: Dec. 26, 2005
(86) PCT No.: PCT/JP2005/023777

§ 371 Date: Jul. 30, 2007

(30) Foreign Application Priority Data
Jan. 31, 2005 (JP) 2005-023016

(51) Int. Cl. H01Q 3/36

(52) U.S. Cl. 342/368

(57) ABSTRACT

A phased array antenna apparatus includes: an antenna array portion having a plurality of antenna elements (2) disposed at equal intervals, and a plurality of phase shifters (3), each phase shifter being connected between the adjacent antenna elements and changing a phase of a transmission signal; a phase shifter control portion (4) controlling each phase shift quantity of the plurality of phase shifters (3); and a power feed path switching portion (5) for switching a power feed path from an external apparatus (6) to the antenna array portion to one of a path from one end of the antenna array portion and a path from the other end of the antenna array portion, and causing the control by the phase shifter control portion (4) to correspond to the switching.

### TECHNICAL FIELD

The present invention relates to a phased array antenna apparatus capable of changing a beam direction by electrically controlling the phase of a received signal from a plurality of antenna elements or the phase of a power feed signal to the antenna elements.

### BACKGROUND ART

A conventional phased array antenna apparatus is known in which the phased array antenna apparatus has an array of a plurality of antenna elements for use with microwaves and millimeter waves, and is capable of changing an overall beam direction without moving the antenna elements themselves by electrically controlling the phase of a received signal from the antenna elements or the phase of a power feed signal to the antenna elements.

For example, an active phased array antenna and antenna controller according to Patent Reference 1 has a configuration in which plural antenna patches and a feeding terminal for applying a high-frequency electric power to a dielectric base material are provided on the dielectric base material, the respective antenna patches and the feeding terminal are connected by feeding lines branching off from the feeding terminal, and a phase shifter which can electrically change the phase of a high-frequency signal passing on the respective feeding lines are arranged to constitute a part of the feeding lines; said phase shifter comprising a microstrip hybrid coupler, which employs paraelectrics as base material and a microstrip stab which employs ferroelectrics as base material and which is electrically connected to the microstrip hybrid coupler; and a dc control voltage being applied to the microstrip stab to change the passing phase shift quantity.

In addition, a phased array antenna apparatus according to Patent Reference 2 comprises: a plurality of element antennas disposed at equal intervals in the horizontal and vertical directions above an antenna aperture; a plurality of digital phase shifters shifting the phase of a received signal from the element antennas or a power feed signal fed to the element antennas; a beam control means calculating phase values to be set in the digital phase shifters in accordance with the beam orientation of the element antennas; and a set phase correction means correcting the phase value calculated by the beam control means and set in a digital phase shifter so that the phase values have equal intervals, using the phase values set in the other digital phase shifters.

FIG. 10 is a block diagram showing a schematic configuration of a phased array antenna apparatus 100 according to such conventional art.

As shown in FIG. 10, the phased array antenna apparatus 100 has three antenna elements 2 disposed in a row at identical intervals d facing the same direction. Each antenna element 2 is connected to a wireless apparatus 6 via a respective digital phase shifter 103, and furthermore, a phase shifter control circuit 104, controlling each digital phase shifter 103, is provided.

In order to make four beam directions selectable, it is necessary for the digital phase shifter 103 to have a bit number of 2 or more. In order to configure the phase shifters as loaded-type phase shifters, four PIN diodes each, serving as switches, are necessary in the case where the bit number is 2. Therefore, the overall number of PIN diodes necessary in the phased array antenna apparatus 100 is [4×(the number of antenna elements 2)]. On the other hand, in order to configure the 2-bit digital phase shifters 103 as switched-line type phase shifters, eight PIN diodes each, serving as switches, are necessary. Therefore, the overall number of PIN diodes necessary in the phased array antenna apparatus 100 is [8×(the number of antenna elements 2)].

### Patent Reference 1: JP 2000-236207A

### Patent Reference 2: JP 2001-308626A

### DISCLOSURE OF THE INVENTION

### Problem to be Solved by the Invention

With the conventional art such as disclosed in the abovementioned Patent Reference 2, a phase shifter for switching the phase of a signal has a plurality of signal transmission lines in which the phase shift quantities differ; control of the phase of the signal is carried out by switching the signal transmission lines via a switch or the like.

However, switches used for microwaves and millimeter waves are expensive, and because many switches are necessary in a phased array antenna apparatus, such phased array antenna apparatuses have been expensive products. Furthermore, because the phased array antenna apparatus requires many switch circuits, the size has been large. In addition, in order to move the beam direction from side to side, the phase shifter is required to have the ability to be set with a large phase shift quantity.

Having been conceived in light of these problems with the conventional technology, an object of the present invention is to provide a phased array antenna apparatus in which plural beam directions can be set as desired while securing a large side-to-side beam direction movement angle, and furthermore in which a simple configuration, low cost, and small overall size is possible.

### Means for Solving Problem

In order to solve the abovementioned object, a phased array antenna apparatus according to the present invention comprises: an antenna array portion having a plurality of antenna elements disposed at equal intervals, and a plurality of phase shifters, each phase shifter being connected between the adjacent antenna elements and changing a phase of a transmission signal; a phase shifter control portion for controlling each phase shift quantity of the plurality of phase shifters; and a power feed path switching portion for switching a power feed path from an external apparatus to the antenna array portion to one of a path from one end of the antenna array portion and a path from the other end of the antenna array portion, and causing the control by the phase shifter control portion to correspond to the switching.

Here, a loaded-type phase shifter, a switched-line type phase shifter, or the like can be given as an example of the phase shifter; however, the phase shifter is not limited thereto.

According to a phased array antenna apparatus configured in this manner, it is possible to select whether to direct a beam in the direction of the right or left relative to a frontal direction by switching a power feed path, from an external apparatus to the antenna array portion, to one of a path from one end of the antenna array portion and a path from the other end of the antenna array portion. It is also possible to select the angle of the beam direction relative to the frontal direction by changing the phase shift quantities set in the plural phase shifters. Through this, the beam direction can be selected at will, as necessary, from among a plurality of directions. In addition, the number of switches necessary for switching the power feed path is less than that of the conventional art, making cost reduction and miniaturization possible. Furthermore, the phase shift quantities per phase shifter along the power feed path are superimposed; therefore, as compared to the conventional art, a larger beam direction movement angle can be secured even when the phase shift quantities set in the individual phase shifters are small.

In addition, in the phased array antenna apparatus of the present invention, at least some of the phase shifters may be adaptive phase shifters capable of switching a characteristic impedance.

Here, the adaptive phase shifter may have a characteristic impedance converter capable of converting a characteristic impedance. In addition, the characteristic impedance converter may have a first transmission line and a second transmission line, the lengths of which are ¼ of a signal wavelength, and the characteristic impedances of which differ from each other; and the characteristic impedance converter may be configured so that signal transmission can be switched between signal transmission by only the first transmission line and signal transmission in which the first transmission line and the second transmission line are connected in parallel. Furthermore, in the characteristic impedance converter, the respective ends of the first transmission line and the second transmission line may be connected to each other by switches capable of being opened and closed; and signal transmission may be performed only by the first transmission line in a state where both of the switches are open, and signal transmission may be performed by the first transmission line and the second transmission line connected in parallel in a state where both of the switches are closed.

According to a phased array antenna apparatus configured in this manner, it is possible to appropriately set the characteristic impedance between each of the antenna elements and convert the impedance as necessary, regardless of which power feed path is used. Through this, it is possible to feed power evenly to each of the antenna elements.

In addition, in a phased array antenna apparatus according to the present invention, the adaptive phase shifter may have a first transmission line and a second transmission line, the lengths of which are ¼ of a signal wavelength, and the characteristic impedances of which differ from each other; the respective ends of the first transmission line and the second transmission line may be connected to each other by PIN diodes, and each end of the first transmission line may be grounded via a coil and a variable capacity diode connected in series; and the adaptive phase shifter may be configured so that signal transmission can be switched between signal transmission by only the first transmission line and signal transmission in which the first transmission line and the second transmission line are connected in parallel, by switching an impedance state of the PIN diodes.

Here, as an example of such a configuration, signal transmission may be performed only by the first transmission line in the case where the PIN diodes are in a high-impedance state during reverse bias, and signal transmission may be performed by the first transmission line and the second transmission line connected in parallel in the case where the PIN diodes are in a low-impedance state during forward bias.

According to a phased array antenna apparatus configured in such a manner, it is possible to reduce the number of PIN diodes and variable capacity diodes necessary in the adaptive phase shifter. Through this, cost reduction and miniaturization are possible.

In addition, in a phased array antenna apparatus according to the present invention, the adaptive phase shifter may have a first variable capacity diode inserted in series in the signal transmission path, a second variable capacity diode between one end of the signal transmission path and the first variable capacity diode and through which the signal transmission path is grounded, and a third variable capacity diode between the other end of the signal transmission path and the first variable capacity diode and through which the signal transmission path is grounded; and the impedance and phase shift quantity of the signal transmission path may be caused to change by causing the capacities of the first variable capacity diode, the second variable capacity diode, and the third variable capacity diode to change.

According to a phased array antenna apparatus configured in such a manner, it is possible to reduce the number of variable capacity diodes necessary in the adaptive phase shifter. Through this, further cost reduction and miniaturization are possible.

According to a phased array antenna apparatus according to the present invention, it is possible to select whether to direct a beam in the direction of the right or left relative to a frontal direction by switching a power feed path, from an external apparatus to the antenna array portion, to one of a path from one end of the antenna array portion and a path from the other end of the antenna array portion. It is also possible to select the angle of the beam direction relative to the frontal direction by changing the phase shift quantities set in the plural phase shifters. Through this, the beam direction can be selected at will, as necessary, from among a plurality of directions. In addition, the number of switches necessary for switching the power feed path is less than that of the conventional art, making cost reduction and miniaturization possible. Furthermore, the phase shift quantities per phase shifter along the power feed path are superimposed; therefore, as compared to the conventional art, a larger beam direction movement angle can be secured even when the phase shift quantities set in the individual phase shifters are small.

### BRIEF DESCRIPTION OF THE DRAWINGS

FIG. 1 is a block diagram showing a schematic configuration of a phased array antenna apparatus according to a first embodiment of the present invention.

FIG. 2 illustrates a loaded-type phase shifter as a specific example of a phase shifter.

FIG. 3 illustrates a switched-line type phase shifter as a specific example of a phase shifter.

FIG. 4 is a block diagram showing beam directions that can be set by the phased array antenna apparatus according to the first embodiment of the present invention.

FIGS. 5(a) and 5(b) are illustrations showing conditions necessary in characteristic impedance between each antenna element in accordance with the power feed direction to the antenna elements, in a phased array antenna apparatus according to a second embodiment of the present invention, wherein FIG. 5(a) indicates a case in which the power is fed from the left side, and FIG. 5(b) indicates a case in which the power is fed from the right side.

FIG. 6 is a schematic diagram illustrating a configuration of an adaptive phase shifter capable of switching a characteristic impedance.

FIGS. 7(a) and 7(b) are illustrations showing a relationship between a power feed direction and a corresponding characteristic impedance in the phased array antenna apparatus including the adaptive phase shifter, wherein FIG. 7(a) indicates a case in which the power is fed from the left side, and FIG. 7(b) indicates a case in which the power is fed from the right side.

FIG. 8 is a schematic diagram illustrating a configuration of an adaptive phase shifter used in a phased array antenna apparatus according to a third embodiment of the present invention.

FIG. 9 is a diagram illustrating a principle of a low-pass adaptive phase shifter used in a phased array antenna apparatus according to a fourth embodiment of the present invention.

FIG. 10 is a diagram illustrating a configuration of the low-pass adaptive phase shifter used in the phased array antenna apparatus according to the fourth embodiment of the present invention.

FIG. 11 is a block diagram showing a schematic configuration of a phased array antenna apparatus according to conventional art.

### REFERENCE NUMERALS

1 phased array antenna apparatus

2 antenna element

3 phase shifter

3A loaded-type phase shifter

3B switched-line type phase shifter

4 phase shifter control circuit

5 power feed path switching circuit

6 wireless apparatus

7a, 7b, 8a, 8b transmission line

10 adaptive phase shifter

λ/4 impedance converter

11a, 11b transmission line

12 antenna element

13, 13A, 13B phase shifter

14 transmission line

20 adaptive phase shifter

21a, 21b transmission line

30 low-pass adaptive phase shifter

### BEST MODE FOR CARRYING OUT THE INVENTION

Hereinafter, embodiments of the present invention shall be described with reference to the drawings.

### First Embodiment

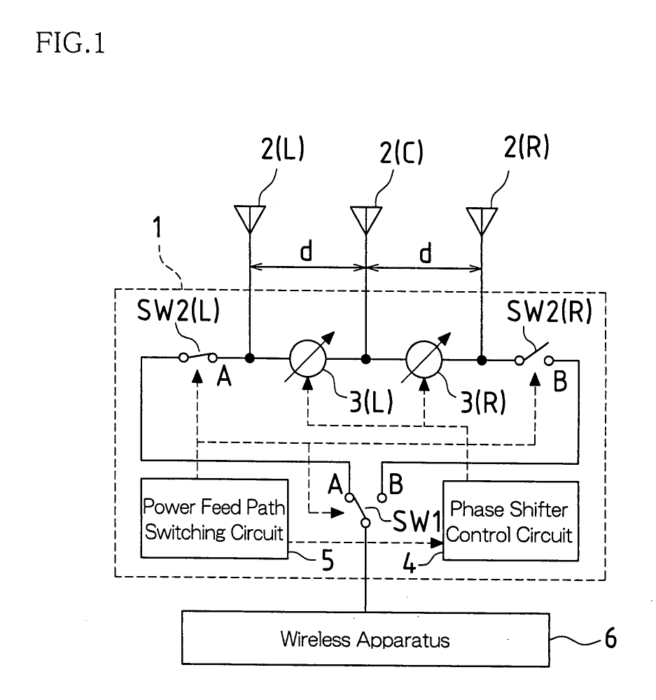

FIG. 1 is a block diagram showing a schematic configuration of a phased array antenna apparatus 1 according to a first embodiment of the present invention.

As shown in FIG. 1, this phased array antenna apparatus 1 comprises three antenna elements 2 disposed in a row at equal intervals d facing the same direction; a total of two phase shifters 3 respectively connected between the antenna elements 2; a phase shifter control circuit 4 for controlling a change in the respective phase shift quantities of the phase shifters 3; one single-pole double-throw type switch SW1; two single-pole single-throw type switches SW2; and a power feed path switching circuit 5 controlling the opening/closing and switching of the switches.

Note that in the following descriptions, the antenna elements 2 disposed on the left, in the center, and on the right are distinguished from one another when necessary by adding (L), (C), or (R) to their respective reference numerals. In the same manner, (L) and (R) are added to the reference numerals of the phase shifters 3 and the switches SW2 to distinguish them from one another when necessary.

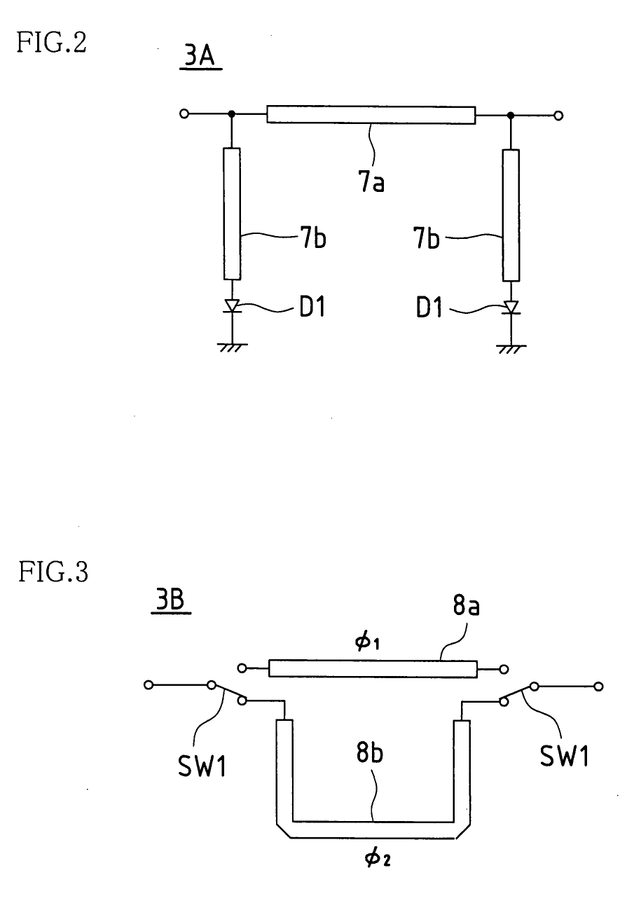

The phase shifter 3 (L) connecting the antenna element 2 (L) on the left side with the antenna element 2 (C) in the center and the phase shifter 3 (R) connecting the antenna element 2 (C) in the center with the antenna element 2 (R) on the right side are capable of changing a phase shift quantity (phase change amount) of the respective signals in two stages, the two stages being φ1 and φ2 (where φ1<φ2). While such a change in phase shift quantity is controlled by the phase shifter control circuit 4 in accordance with operation of the power feed path switching circuit 5, the respective phase shift quantities set in each phase shifter 3 are all limited to a combination of φ1 or φ2. Note that specific configuration examples of the phase shifter 3 shall be given later with reference to FIGS. 2 and 3.

The antenna element 2 (L) on the left side is connected, via the switch SW2 (L), to an “A” contact located on one of the switching sides of the switch SW1. The antenna element 2 (R) on the right side is connected, via the switch SW2 (R), to a “B” contact located on the other switching side of the switch SW1. A contact on the permanently-connected side of the switch SW1 is connected to an external wireless apparatus 6.

Opening/closing and switching of these switches is performed by the power feed path switching circuit 5 so as to be mutually cooperative. That is, when the switch SW1 is switched to the “A” contact, the switch SW2 (L) is closed and the switch SW2 (R) is opened. Conversely, when the switch SW1 is switched to the “B” contact, the switch SW2 (L) is opened and the switch SW2 (R) is closed.

Note that a switch whose switching is electrically controllable using a PIN diode (p-intrinsic-n diode) can be given as a specific example of these switches. With a PIN diode, a low-impedance state during forward bias is equivalent to the switch being ON, and a high-impedance state during reverse bias is equivalent to the switch being OFF. Hereinafter, a low-impedance state during forward bias of the PIN diode shall simply be denoted as “ON”, and a high-impedance state during reverse bias of the PIN diode shall simply be denoted as “OFF”.

When using a PIN diode in a switch, one PIN diode is necessary in the single-pole single-throw type switch SW2, whereas two PIN diodes are necessary in the single-pole double-throw type switch SW1.

In addition, a receiver receiving microwaves or millimeter waves, a transmitter transmitting microwaves or millimeter waves, or a transmitter/receiver performing both transmitting and receiving can be given as examples of the wireless apparatus 6; however, the wireless apparatus 6 is not limited thereto.

FIG. 2 illustrates a loaded-type phase shifter 3A as a specific example of the phase shifter 3. This loaded-type phase shifter 3A is configured so that one end of a transmission line 7b is connected to one end of a transmission line 7a, while one end of another transmission line 7b is connected to the other end of the transmission line 7a; the other ends of the transmission lines 7b are grounded by PIN diodes D1 respectively.

Change in the overall phase shift quantity of the loaded-type phase shifter 3A is carried out by the PIN diodes D1. Note that the respective phase shift quantities of the transmission line 7a and the transmission lines 7b are set so that the overall phase shift quantity is φ1 in the case where the PIN diodes D1 are both ON and the overall phase shift quantity is φ2 in the case where the PIN diodes D1 are both OFF.

Two PIN diodes are used in this loaded-type phase shifter 3A; however, because the necessary number of loaded-type phase shifters 3A in the phased array antenna apparatus 1 is [number of antenna elements 2−1], a total of [2×(number of antenna elements 2−1)] PIN diodes are necessary. Furthermore, two PIN diodes are necessary for the switch SW1, and one PIN diode is necessary for each of the two switches SW2; therefore, the overall number of PIN diodes necessary in the phased array antenna apparatus 1 is:

4+2×(number of antenna elements 2−1)

FIG. 3 illustrates a switched-line type phase shifter 3B as another specific example of the phase shifter 3. This switched-line type phase shifter 3B has a transmission line 8a having a phase shift quantity of φ1 and a transmission line 8b having a phase shift quantity of φ2, and is configured with respective ends of the transmission lines 8a and 8b connected to each other by single-pole double-throw type switches SW1.

Changing the overall phase shift quantity of the switched-line type phase shifter 3B is carried out by switching the switches SW1 in cooperation to use one of the transmission line 8a and the transmission line 8b.

In the case where the switches SW1 of the switched-line type phase shifter 3B are configured of PIN diodes, two PIN diodes are necessary for one switch SW1, and therefore a total of four PIN diodes are necessary in the switched-line type phase shifter 3B. Because the necessary number of switched-line type phase shifters 3B in the phased array antenna apparatus 1 is [number of antenna elements 2−1], a total of [4×(number of antenna elements 2−1)] PIN diodes are necessary. Furthermore, two PIN diodes are necessary for the switch SW1, and one PIN diode is necessary for each of the two switches SW2; therefore, the overall number of PIN diodes necessary in the phased array antenna apparatus 1 is:

4+4×(number of antenna elements 2−1)

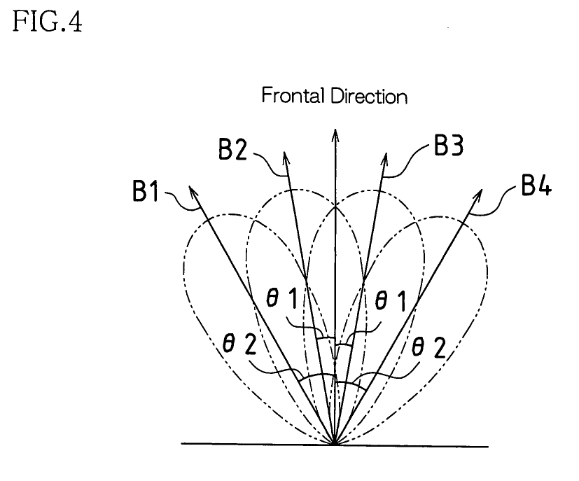

FIG. 4 is a block diagram showing beam directions that can be set by the phased array antenna apparatus 1. Descriptions shall be provided for each of two switching states of the switches SW1 within the phased array antenna apparatus 1.

(1) When the Switch SW1 is Switched to the “A” Contact

As described above, the switch SW2 (L) is closed and the switch SW2 (R) is opened. Through this, the antenna elements 2 are in a state connected to the wireless apparatus 6, the antenna element 2 (L) on the left side being connected via the switch SW2 (L) and the switch SW1. For this reason, with the phase of the signal in the antenna element 2 (L) on the left side used as a reference, the difference in the phase of the signal in the antenna element 2 (C) in the center relative to the abovementioned reference is the phase shift quantity set in the phase shifter 3, and the difference in the phase of the signal in the antenna element 2 (R) on the right side relative to the abovementioned reference is two times the phase shift quantity set in the phase shifter 3.

When the phase shift quantities set in each phase shifter 3 are all φ1, the beam direction set in the phased array antenna apparatus 1 is a B2 direction, facing left of the frontal direction by the amount of an angle θ1. However, the following holds true:

sin(θ1)=φ1/d

On the other hand, when the phase shift quantities set in each phase shifter 3 are all φ2, the beam direction set in the phased array antenna apparatus 1 is a B1 direction, facing left of the frontal direction by the amount of an angle θ2. However, the following holds true:

sin(θ2)=φ2/d

(2) When the Switch SW1 is Switched to the “B” Contact

As described above, the switch SW2 (L) is opened and the switch SW2 (R) is closed. Through this, the antenna elements 2 are in a state connected to the wireless apparatus 6, the antenna element 2 (R) on the right side being connected via the switch SW2 (R) and the switch SW1. For this reason, with the phase of the signal in the antenna element 2 (R) on the right side used as a reference, the difference in the phase of the signal in the antenna element 2 (C) in the center relative to the abovementioned reference is the phase shift quantity set in the phase shifter 3, and the difference in the phase of the signal in the antenna element 2 (L) on the left side relative to the abovementioned reference is two times the phase shift quantity set in the phase shifter 3.

When the phase shift quantities set in each phase shifter 3 are all φ1, the beam direction set in the phased array antenna apparatus 1 is a B3 direction, facing right of the frontal direction by the amount of the angle θ1.

On the other hand, when the phase shift quantities set in each phase shifter 3 are all φ2, the beam direction set in the phased array antenna apparatus 1 is a B4 direction, facing right of the frontal direction by the amount of the angle θ2.

According to the first embodiment as described thus far, the beam direction can be selected so as to face to the right or left relative to a frontal direction by switching the switch SW1 and the switches SW2, and the angle of the beam direction relative to the frontal direction can be selected by changing each phase shift quantity in each phase shifter 3. Through this, the beam direction of the phased array antenna apparatus 1 can be selected at will, as necessary, from among a plurality of directions.

In the case where each switch is configured of PIN diodes, the overall number of PIN diodes necessary in the phased array antenna apparatus 1 is [4+2×(number of antenna elements 2−1)] when using loaded-type phase shifters 3A shown in FIG. 2 as the phase shifters 3, whereas the overall number of PIN diodes necessary in the phased array antenna apparatus 1 is [4+4×(number of antenna elements 2−1)] when using switched-line type phase shifters 3B shown in FIG. 3 as the phase shifters 3. In other words, the necessary number of PIN diodes is less than that of the conventional art; the necessary number of PIN diodes can be greatly reduced particularly by using the loaded-type phase shifter 3A, making cost reduction and miniaturization possible.

Note that in the case of using the switched-line type phase shifters 3B shown in FIG. 3 as the phase shifters 3, the beam direction of the phased array antenna apparatus 1 can be selected from among an even greater number of directions if the switched-line type phase shifters 3B are provided with three or more transmission lines having mutually different phase shift quantities.

### Second Embodiment

Impedance matching is not taken into particular considering in the above descriptions of the first embodiment; however, a second embodiment, which shall be described hereinafter, takes impedance matching into consideration. It should be noted that details aside from those described hereafter are identical to those described in the first embodiment; accordingly, identical constituent elements are given identical reference numerals, and descriptions shall center mainly on the differences.

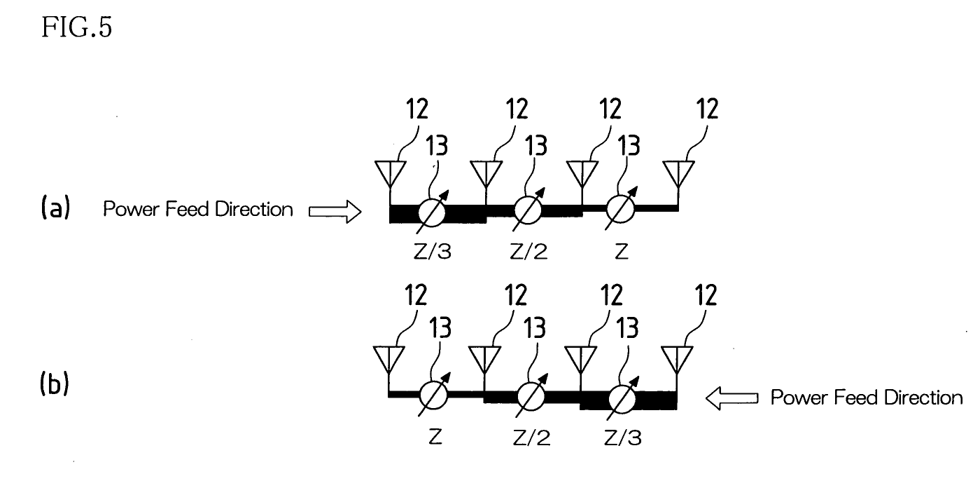

FIGS. 5(a) and 5(b) are illustrations showing conditions necessary in characteristic impedance between each of antenna elements 12 in accordance with the power feed direction to the antenna elements 12, in a phased array antenna apparatus 1 according to the second embodiment of the present invention, wherein FIG. 5(a) indicates a case in which the power is fed from the left side, and FIG. 5(b) indicates a case in which the power is fed from the right side. Note that the number of antenna elements 12 is four, and the input impedance of each antenna element 12 is Z.

When power is fed from one side in the case where identical phase shifters 13 are simply connected between each antenna element 12, there is a problem that, due to the input impedance of each antenna element 12, a relationship of the characteristic impedances between antenna elements 12, and the like, the power fed to each antenna element 12 is not uniform. For this reason, it is necessary to convert the characteristic impedance between the antenna elements 12 including the phase shifter 13 in order to feed a uniform power to each antenna element 12.

In other words, in the case where the power is fed from the left, it is necessary for the characteristic impedance between the antenna elements 12 including the phase shifter 13 to be a value of Z on the right side, a value of Z/2 in the center, and a value of Z/3on the left side, as shown in FIG. 5(a).

On the other hand, in the case where the power is fed from the right, it is necessary for the characteristic impedance between the antenna elements 12 including the phase shifter 13 to be a value of Z on the left side, a value of Z/2 in the center, and a value of Z/3 on the right side, as shown in FIG. 5(b).

Therefore, it is necessary for the configuration to allow both characteristic impedances in the phase shifters 13 on the right and left sides to be able to switch between 3/Z and Z.

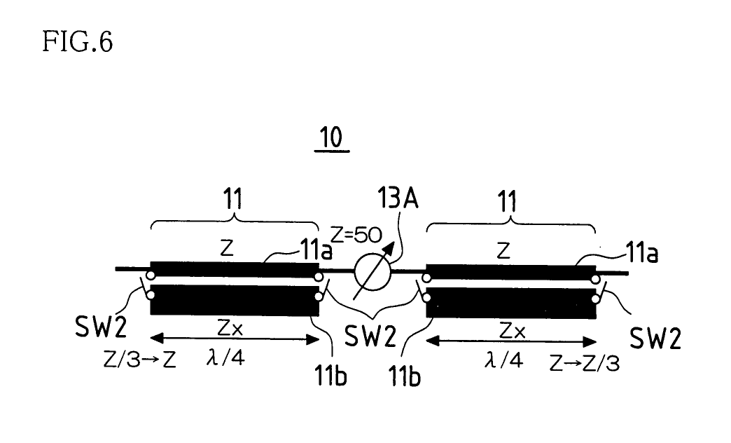

FIG. 6 is a schematic diagram illustrating a configuration of a phase shifter 10 (hereinafter referred to as an “adaptive phase shifter”) capable of switching a characteristic impedance. Note that the wavelength of a signal is represented by λ.

The adaptive phase shifter 10 is provided with a phase shifter 13A (the phase shift quantity being a predetermined value and the characteristic impedance Z being 50Ω), and λ/4 impedance converters 11 are connected to both ends of the adaptive phase shifter 10. Each of these λ/4 impedance converters 11 is configured so that one end of a transmission line 11a (having a length of λ/4 and a characteristic impedance of 50Ω) is in a state capable of being connected with/disconnected from one end of a transmission line 11b (having a length of λ/4 and a characteristic impedance of Zx) by a single-pole single-throw type switch SW2, and the respective other ends of the transmission lines 11a and 11b are in a state capable of being connected with/disconnected from each other by another switch SW2.

When the switches SW2 at both ends of the transmission line 11a and the transmission line 11b are disconnected, only the transmission line 11a is active in the λ/4 impedance converter 11; therefore, the characteristic impedance of the transmission lines on the left and right of the phase shifter 13A matches the characteristic impedance Z (50Ω) of the transmission line 11a.

On the other hand, when the switches SW2 at both ends of the transmission line 11a and the transmission line 11b are connected, both the transmission lines 11a and 11b are connected in parallel in the λ/4 impedance converter 11; therefore, the parallel combined characteristic impedance is as follows:

1/(1/Z+1/Zx)

In addition, so that the characteristic impedance at both ends of the adaptive phase shifter 10 is Z/3, the characteristic impedance of the phase shifter 13A is Z; therefore, the parallel combined characteristic impedance of the transmission line 11a and the transmission line 11b for impedance conversion is required to be:

√(Z×Z/3)

Therefore, it is necessary to determine Zx so as to fulfill the following:

1/(1/z+1Zx)=√(Z×Z/3)

Solving this equation for Zx results in:

Zx=Z/(√3·1)

Substituting Z=50[Ω] here results in:

Zx≈=69[Ω]

In addition, the value of the parallel combined characteristic impedance at this time is about 29Ω.

Through the above configuration, an adaptive phase shifter 10 capable of switching the characteristic impedance between 3/Z and Z is realized. Note that the numerical values given above are examples only.

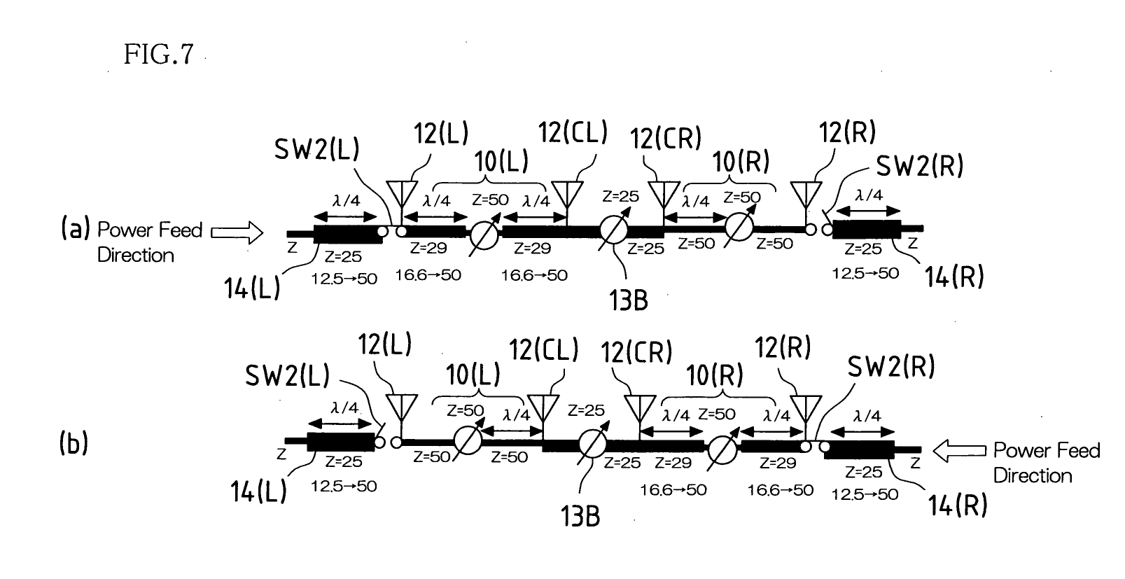

FIGS. 7(a) and 7(b) are illustrations showing a relationship between a power feed direction and a corresponding characteristic impedance in the phased array antenna apparatus 1 including the adaptive phase shifter 10, wherein FIG. 7(a) indicates a case in which the power is fed from the left side, and FIG. 7(b) indicates a case in which the power is fed from the right side. Note that the number of antenna elements 12 is four, and the input impedance of each antenna element 12 is 50Ω. In the following descriptions, the antenna elements 12 shall be distinguished from one another when necessary by adding (L), (CL), (CR), or (R) to the reference numerals thereof in order from the left.

As shown in FIGS. 7(a) and 7(b), an antenna element 12 (L) on the left side and an antenna element 12 (CL) to the right thereof are connected via the abovementioned adaptive phase shifter 10 (hereinafter, 10 (L) shall be used as the reference numeral thereof as necessary); an antenna element 12 (R) on the right side and an antenna element 12 (CR) to the left thereof are connected via another adaptive phase shifter 10 (hereinafter, 10 (R) shall be used as the reference numeral thereof as necessary); and the antenna element 12 (CL) and the antenna element 12 (CR) are connected via a phase shifter 13B (the phase shift quantity being a predetermined value and the characteristic impedance Z being 25Ω).

Furthermore, the antenna element 12 (L) is connected via a single-pole single-throw type switch SW2 (L) to a left side power feed transmission line 14 (L) (having a length of λ/4 and a characteristic impedance of 25Ω), and the antenna element 12 (R) is connected via another switch SW2 (R) to a right side power feed transmission line 14 (R) (having a length of λ/4 and a characteristic impedance of 25Ω). Note that the transmission line 14 (L) and the transmission line 14 (R) have functions for converting their respective characteristic impedances.

In the case where the power is fed from the left, first, the characteristic impedance is converted by the transmission line 14 (L), and the power is fed to the antenna element 12 (L) via the switch SW2 (L), as shown in FIG. 7(a). From there, the power is fed to the antenna element 12 (CL) via the adaptive phase shifter 10 (L). Note that in the adaptive phase shifter 10 (L), both switches SW2 are closed, and impedance conversion is carried out by combining the characteristic impedance of the parallel transmission lines. From there, the power is fed to the antenna element 12 (CR) via the phase shifter 13B. Furthermore, the power is fed to the antenna element 12 (R) via the adaptive phase shifter 10 (R). Note that both switches SW2 are open in the adaptive phase shifter 10 (R).

In the case where the power is fed from the right, first, the characteristic impedance is converted by the transmission line 14 (R), and the power is fed to the antenna element 12 (R) via the switch SW2 (R), as shown in FIG. 7(b). From there, the power is fed to the antenna element 12 (CL) via the adaptive phase shifter 10 (R). Note that in the adaptive phase shifter 10 (R), both switches SW2 are closed, and impedance conversion is carried out by combining the characteristic impedance of the parallel transmission lines. From there, the power is fed to the antenna element 12 (CL) via the phase shifter 13B. Furthermore, the power is fed to the antenna element 12 (R) via the adaptive phase shifter 10 (L). Note that both switches SW2 are open in the adaptive phase shifter 10 (L).

According to the configuration of the second embodiment as described thus far, the characteristic impedance can be appropriately set between each antenna element 12, and impedance conversion can be performed as necessary, regardless of which direction, left or right, the power is fed from. Through this, it is possible to feed power evenly to each antenna element 12.

### Third Embodiment

Hereinafter, a third embodiment shall be described, wherein a phased array antenna apparatus 1 uses an adaptive phase shifter 20 capable of switching a characteristic impedance by using a different configuration than that of the adaptive phase shifter 10 described in the second embodiment. It should be noted that details aside from those described hereafter are identical to those described in the first and second embodiments; accordingly, identical constituent elements are given identical reference numerals, and descriptions shall center mainly on the differences.

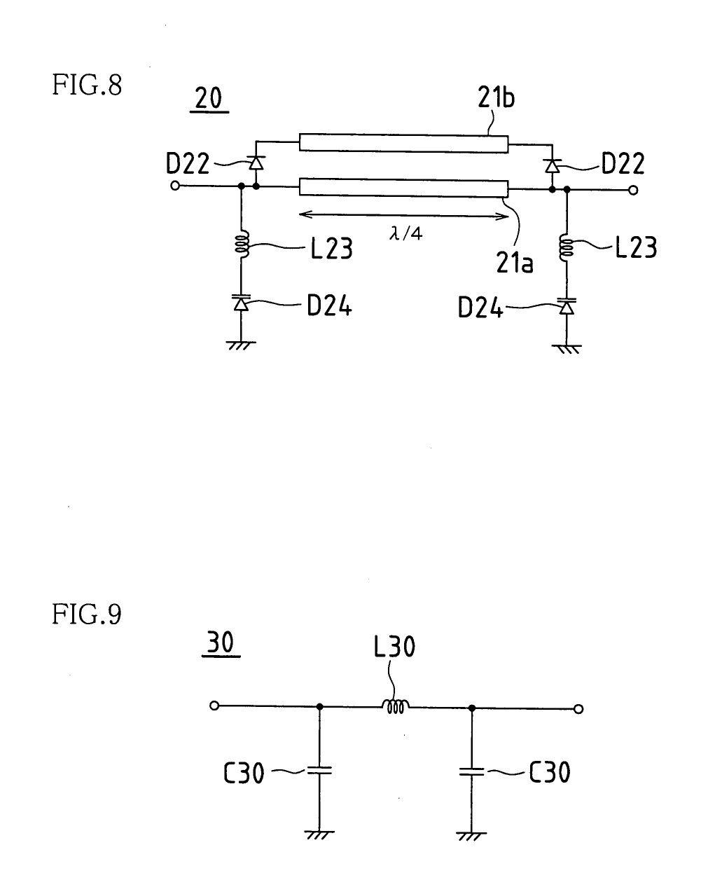

FIG. 8 is a schematic diagram illustrating a configuration of the adaptive phase shifter 20 used in the phased array antenna apparatus 1 according to the third embodiment of the present invention.

The adaptive phase shifter 20 comprises a loaded-type transmission line 21a (having a length of λ/4) and a loaded-type transmission line 21b (having a length of λ/4). One end of the transmission line 21a is connected to one end of the transmission line 21b via a PIN diode D22, and the other end of the transmission line 21a is connected to the other end of the transmission line 21b via another PIN diode D22. Furthermore, the ends of the transmission line 21a are grounded via a coil L23 and a variable capacity diode D24.

With an adaptive phase shifter 20 configured in this manner, a load can be changed by the variable capacity diode D24. In addition, by switching the PIN diodes D22 ON/OFF, the characteristic impedance can be changed to one of the value of the transmission line 21a and the parallel combined value of the transmission line 21a and the transmission line 21b.

A relationship between the loaded-type load and a phase shift quantity θ3 can be found through the following equation.

θ₃=π/2Bz+(Bz)³/6 [Equation 1]

B: variable load admittance

Z: transmission path characteristic impedance

According to the configuration of the third embodiment as described above, the total number of PIN diodes D22 and variable capacity diodes D24 necessary in the adaptive phase shifter 20 is four; the necessary number can thus be reduced even more than as in the second embodiment. Through this, cost reduction and miniaturization is possible.

### Fourth Embodiment

Hereinafter, a fourth embodiment shall be described, wherein a phased array antenna apparatus 1 uses a low-pass adaptive phase shifter 30 capable of switching a characteristic impedance by using a different configuration than that of the adaptive phase shifter 10 described in the second embodiment and the adaptive phase shifter 20 described in the third embodiment. It should be noted that details aside from those described hereafter are identical to those described in the first through third embodiments; accordingly, identical constituent elements are given identical reference numerals, and descriptions shall center mainly on the differences.

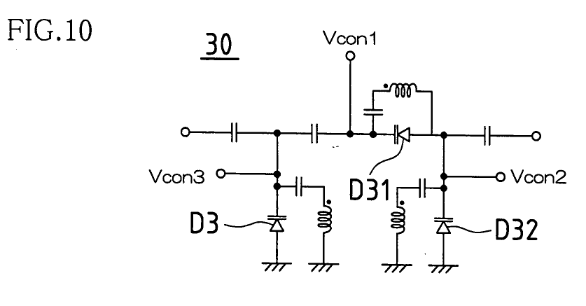

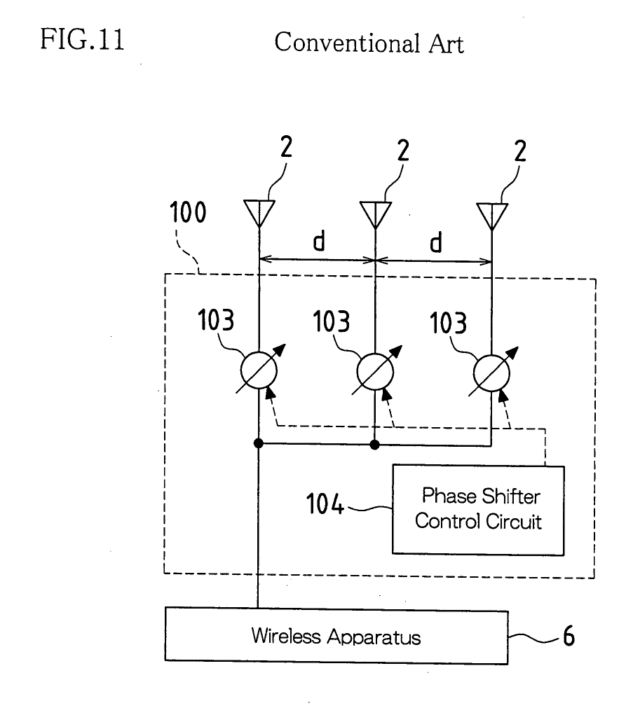

FIG. 9 is a diagram illustrating a principle of the low-pass adaptive phase shifter 30 used in a phased array antenna apparatus 1 according to the fourth embodiment of the present invention. FIG. 10 is a schematic diagram illustrating a configuration of the low-pass adaptive phase shifter 30.

The principle of the low-pass adaptive phase shifter 30 is as follows: in a low-pass filter in which both ends of a coil L30 are grounded via capacitors C30, as shown in FIG. 9, impedance and phase shift quantity are caused to change by changing an inductance value of the coil L30 and the capacitance value of the capacitors C30.

The low-pass filter type circuit shown in FIG. 10 can be given as a specific configuration example. Here, a variable capacity diode D31 is inserted in series in a signal transmission path, and furthermore, in this signal transmission path, the circuit is grounded by a variable capacity diode D32 between one end of the signal transmission path and the variable capacity diode D31, and is grounded by a variable capacity diode D33 between the other end of the signal transmission path and the variable capacity diode D31. In the low-pass adaptive phase shifter 30, it is possible to cause the impedance and phase shift quantity to change by changing voltages supplied to voltage input terminals Vcon1 to Vcon3 and changing capacitances of the variable capacity diodes D31 to D33.

Note that the phase shift quantity θ4 (phase change amount) and impedance have the following relationship.

B=tan(θ_{4/}2) B: normalized admittance

X=sin(θ₄) X: normalized impedance

Z_{C}=Z₀/B Z_{C}: capacitor impedance

Z_{L}=Z₀X Z_{L}: inductor impedance [Equation 2]

According to the configuration of the fourth embodiment as described above, the total number of variable capacity diodes D24 necessary in the adaptive phase shifter 30 is four; the necessary number can thus be reduced even more than as in the third embodiment. Through this, further cost reduction and miniaturization is possible.

The invention may be embodied in other forms without departing from the spirit or essential characteristics thereof. Accordingly, the embodiments disclosed in this application are to be considered in all respects as illustrative and not limiting. The scope of the invention is indicated by the appended claims rather than by the foregoing description. Furthermore, all changes which come within the meaning and range of equivalency of the claims are intended to be embraced therein.

This application claims the benefit of Japanese Patent Application No. 2005-23016, filed Jan. 31, 2005, which is hereby incorporated by reference in its entirety. Furthermore, the documents referred to in the present specification are also incorporated herein by reference in their entirety.

### INDUSTRIAL APPLICABILITY

The present invention is applicable in, for example, a phased array antenna apparatus capable of changing a beam direction by electrically controlling the phase of a received signal from a plurality of antenna elements or a power feed signal fed to the antenna elements.

1. A phased array antenna apparatus comprising:
an antenna array portion having a plurality of antenna elements disposed at equal intervals, and a plurality of phase shifters, each phase shifter being connected between the adjacent antenna elements and changing a phase of a transmission signal;
a phase shifter control portion for controlling each phase shift quantity of the plurality of phase shifters; and
a power feed path switching portion for switching a power feed path from an external apparatus to the antenna array portion to one of a path from one end of the antenna array portion and a path from the other end of the antenna array portion, and causing the control by the phase shifter control portion to correspond to the switching,
wherein at least some of the phase shifters are adaptive phase shifters capable of switching a characteristic impedance.

2. The phased array antenna apparatus according to claim 1, wherein the phase shifters are loaded-type phase shifters.

3. The phased array antenna apparatus according to claim 1, wherein the phase shifters are switched-line type phase shifters.

4. (canceled)

5. The phased array antenna apparatus according to claim 1, wherein the adaptive phase shifter has a characteristic impedance converter capable of converting a characteristic impedance.

6. The phased array antenna apparatus according to claim 5,
wherein the characteristic impedance converter has a first transmission line and a second transmission line, the lengths of which are ¼ of a signal wavelength, and the characteristic impedances of which differ from each other; and
the characteristic impedance converter is configured so that signal transmission can be switched between signal transmission by only the first transmission line and signal transmission in which the first transmission line and the second transmission line are connected in parallel.

7. The phased array antenna apparatus according to claim 6,
wherein in the characteristic impedance converter, the respective ends of the first transmission line and the second transmission line are connected to each other by switches capable of being opened and closed; and
signal transmission is performed only by the first transmission line in a state where both of the switches are open, and signal transmission is performed by the first transmission line and the second transmission line connected in parallel in a state where both of the switches are closed.

8. The phased array antenna apparatus according to claim 1,
wherein the adaptive phase shifter has a first transmission line and a second transmission line, the lengths of which are ¼ of a signal wavelength, and the characteristic impedances of which differ from each other;
the respective ends of the first transmission line and the second transmission line are connected to each other by PIN diodes, and each end of the first transmission line is grounded via a coil and a variable capacity diode connected in series; and
the adaptive phase shifter is configured so that signal transmission can be switched between signal transmission by only the first transmission line and signal transmission in which the first transmission line and the second transmission line are connected in parallel, by switching an impedance state of the PIN diodes.

9. The phased array antenna apparatus according to claim 8, wherein signal transmission is performed only by the first transmission line in the case where the PIN diodes are in a high-impedance state during reverse bias, and signal transmission is performed by the first transmission line and the second transmission line connected in parallel in the case where the PIN diodes are in a low-impedance state during forward bias.

10. The phased array antenna apparatus according to claim 1,
wherein the adaptive phase shifter has a first variable capacity diode inserted in series in the signal transmission path, a second variable capacity diode between one end of the signal transmission path and the first variable capacity diode and through which the signal transmission path is grounded, and a third variable capacity diode between the other end of the signal transmission path and the first variable capacity diode and through which the signal transmission path is grounded; and
the impedance and phase shift quantity of the signal transmission path is caused to change by causing the capacities of the first variable capacity diode, the second variable capacity diode, and the third variable capacity diode to change.
